(19) United States
(12) Patent Application Publication
(10) Pub. No.: US 2023/0066278 A1
(43) Pub. Date: Mar. 2, 2023

(54) STRUCTURED BATTERIES AND USAGE THEREOF

(71) Applicant: Mint Controls Inc., Newport Beach, CA (US)

(72) Inventor: Jason Andrew Mindte, Newport Beach, CA (US)

(21) Appl. No.: 17/900,748

(22) Filed: Aug. 31, 2022

Related U.S. Application Data
(60) Provisional application No. 63/238,971, filed on Aug. 31, 2021.

(51) Int. Cl. H01M 10/653; H01M 50/14; H01M 10/0585; H01M 4/583; H01M 10/655; H01M 10/48; H01M 10/46

(52) U.S. Cl. CPC H01M 10/653; H01M 50/14; H01M 10/0585; H01M 4/583; H01M 10/655; H01M 10/482; H01M 10/486; H01M 10/465; H01M 2220/20; H01M 2004/028

(57) ABSTRACT

A structured battery having a battery core disposed between two carbon fiber layers. The battery core includes one or more layers of graphene battery sheets configured to store electricity. The structured battery also includes a honeycomb layer configured to transfer heat from the one or more layers of graphene battery sheets to the carbon fiber layers. The structured battery can be used as a structural component such as components of an electric vehicles, components of a building, or components of an appliance.

### CROSS-REFERENCE TO RELATED APPLICATIONS

This application claims the benefit of U.S. Provisional Application No. 63/238,971, filed Aug. 31, 2021, which is incorporated herein by reference in its entirety.

### BACKGROUND

Electricity production creates more greenhouse gases than any other source. In fact, electricity production using traditional methods creates more greenhouse gases than all of the vehicles on the ground and in the air combined. The average U.S. home uses around 11,000 kWh of energy each year, and much of that energy is wasted.

Most of the energy used today comes from coal, nuclear, and other non-renewable power plants. Producing energy using these resources creates massive amounts of air, land, and water pollution. Traditional methods of energy production create hazards to human health as well. 66% of sulfur dioxide (SO2) and 29% of nitrogen oxides (NOx) come from electricity generation.

Using traditional methods, electricity generation also creates ground-level ozone (O3), particulate matter, and carbon dioxide (CO2). In addition to causing lung inflammation, increasing the chance of lung disease and heart disease, electricity generation is a major contributor to global climate change.

Renewable energy sources allow for the production of electricity without creating harmful smog, toxic buildup in the air and water, and environmental impacts caused by coal mining and gas extraction.

While lithium-ion batteries have shown some promise as an energy generation and storage solution, the environmental cost is much too high for lithium-ion to be considered a truly “green” option. Sourcing the raw materials used to create lithium-ion batteries is far from environmentally-friendly. Another issue is that damages to lithium-ion batteries can lead to fire and explosion. These batteries store a lot of power in a relatively small space. Even the smallest pinprick can create a major problem. This has been demonstrated time and time again.

When used for electric vehicles (EVs), lithium-ion batteries make-up a large portion of the vehicle's weight without fulfilling any load-bearing function. This creates a problem for larger vehicles and drivers needing to travel long distances without stopping to recharge.

### BRIEF DESCRIPTION OF THE FIGURES

FIG. 1 illustrates an exploded view of a structured battery according to an embodiment of the present disclosure;

FIG. 2 illustrates an example honeycomb layer that can be implemented within a structured battery according to an embodiment of the present disclosure;

FIG. 3 illustrates an exploded view of another structured battery according to an embodiment of the present disclosure; and

FIG. 4 illustrates example arrangements of carbon fiber plies in a face sheet according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Energy efficiency is important to every person on the planet. Using clean, renewable energy reduces reliance on fossil fuels and creates a more sustainable future. Unfortunately, most clean energy solutions do not provide the reliability, flexibility, safety, or efficiency most homes and businesses require to maintain their current energy needs.

When provided alone, solar panels and wind turbines simply cannot provide a consistent source of energy. Without proper energy storage, homeowners, leaders, and businesses have no way to utilize the energy produced when they need it most.

Although several companies have attempted to create lithium-ion battery back-ups, these batteries are expensive and harmful to produce. Lithium-ion is prone to fire and explosion. Any damage to the outside of the battery can cause a major problem. Another issue, the large size and lack of flexibility makes lithium-ion batteries difficult, if not impossible, to use in multiple applications.

Graphene has shown a lot of promise as an effective replacement for lithium-ion. Graphene can be used to store power generated by solar and other green technologies. Graphene batteries can hold large amounts of power and charge and discharge in very little time. This makes graphene perfect for applications where reliable access to power is important. Comprised entirely of carbon, graphene is easy to source and more environmentally-friendly than any other type of battery.

Graphene is lighter and slimmer than lithium-ion cells. The flexibility of graphene makes custom shapes and sizes possible. Graphene is also safer than lithium-ion batteries. Graphene is resilient to overheating, fire, and explosion.

In some embodiments, structured batteries comprising graphene sheets and carbon fiber can be used as a solution for efficient storage of energy. The addition of carbon fiber increases the rigidity of the battery, allowing for the production of large sheets which can be used in place of metal on vehicles (e.g., roof, trunk, hood, etc.), large appliances, rooftops, and other applications.

In some embodiments, when energy is collected using renewable sources, such as solar, wind, etc., structured graphene batteries may be used to store the energy for use when and where it is needed most. The lightweight, rigid sheets may enable energy storages to be implemented as (or incorporated into) structural components of different apparatuses or devices (e.g., electric vehicles, mobile computers, building structures, etc.). Using graphene ensures a safe, reliable, eco-friendly, and effective solution.

The structured battery, in some embodiments, works as both a power source and part of the structure that it is powering. The lightweight battery provides reliable, continuous power to buildings, EVs, farms, and more. Anything with a large surface area could be fitted with the structured battery.

In some embodiments, the structured battery includes multiple layers, comprising two external carbon fiber layers and a core disposed in between the two carbon fiber panels. While conventional carbon fiber panels are made with polyacrylonitrile, rayon and/or petroleum pitch, the structured battery in some embodiments has a composition of aluminum (e.g., 20%-40%), graphene (e.g., 5%-15%), and carbon fiber (e.g., 50%-70%).

Each of the carbon fiber layers may have a thickness between 0.3 mm to 1.5 mm. In some embodiments, each carbon fiber panel may have a thickness of 0.5 mm. In some embodiments, each carbon fiber layer may have a thickness of 1.0 mm. In some embodiments, the thickness of the carbon fiber layers may be determined based on the application in which the structured battery is used.

The core of the structure battery may include one or more graphene battery layers (also referred to as graphene battery cells). Each of the one or more graphene battery layers may have a composition and manufactured using the techniques disclosed in a commonly-owned and concurrently filed U.S. patent application Ser. No. 17/900,729, titled “Graphene Battery As Energy Storage For Appliances,” which is incorporated herein by reference in its entirety. The one or more graphene battery layers may be stacked on top of each other, and encompassed by the two carbon fiber layers. The carbon fiber layers utilize a low density core and relatively stiff face sheets that are used to house the one or more graphene battery layers, giving the structured battery the ability to act like a standard carbon fiber panel, but embedded in this structure is the graphene battery.

In some embodiments, micro sensors and computer processors can be embedded within the structured battery as well. The micro sensors can detect charge levels, temperature, and other information associated with the layers of graphene batteries. The computer processors in the structured battery can configure the graphene battery to provide power to appliances connected to the structured battery. In some embodiments, the computer processors are communicatively coupled to the micro sensors, and are configured to provide power to a machine based on information detected from the micro sensors.

The structured battery has a negative electrode and a positive electrode of graphene and a high tensile strength carbon fiber casing. The structured battery is lightweight, strong, and rigid. It has an extremely high energy density. The battery is as strong as aluminum, but weighs less. The thin pieces can be molded into a variety of shapes.

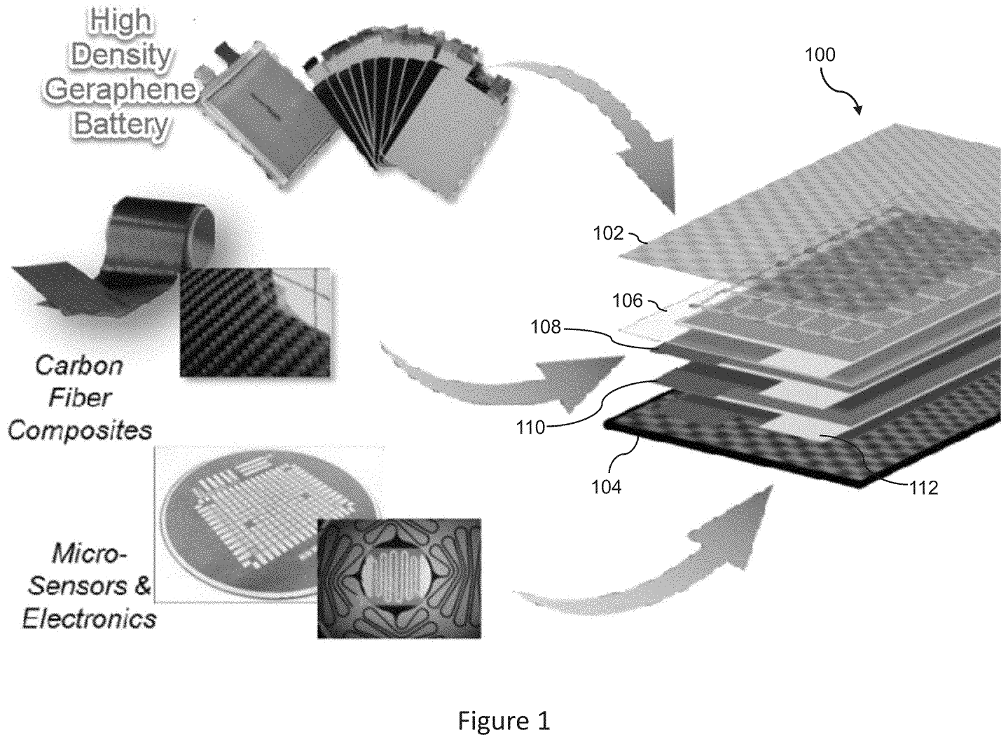

FIG. 1 illustrates an example structured battery 100. The structured battery 100 includes two carbon fiber layers 102 and 104 that “sandwich” the core of the structured battery 100. The core of the structured battery 100 may include multiple layers of graphene battery cells 108, 110, and 112. Each of the graphene battery cells may include components such as a positive current collector attached to a graphene anode, a negative current collector attached to a graphene cathode, and a separator that separates the graphene anode and the graphene cathode (e.g., disposed between the graphene anode and the graphene cathode). The core may also include a layer 106, on which micro-sensors and other electronic components such as computer processors can be disposed.

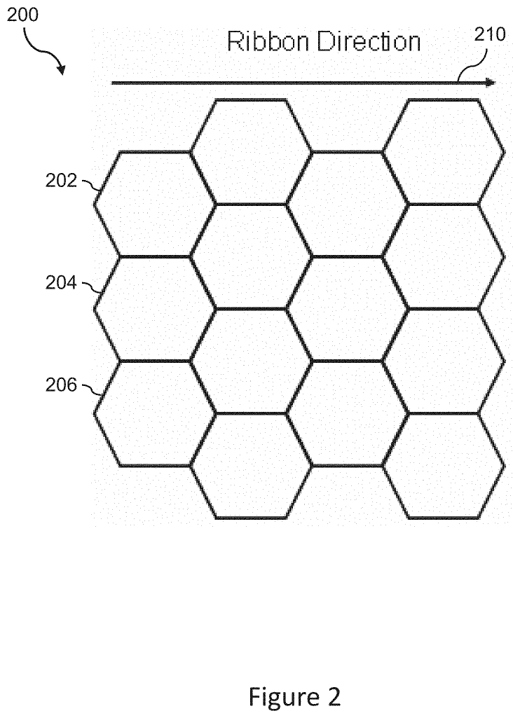

In some embodiments, the core of the structured battery may also include one or more honeycomb layers. In some embodiments, each honeycomb layer may be made with a metal, an alloy, or a material having a heat conducting characteristic above a threshold. In one non-limiting example, each honeycomb layer in the structured battery is made with aluminum. Each honeycomb layer includes multiple honeycomb cells that are connected to each other. The purpose of the honeycomb layers is to dissipate heat from the graphene battery (e.g., transferring the heat from the graphene batteries to the carbon fiber layers, which can be heat resistant). Each of the honeycomb cells may have a diameter between 5 mm and 10 mm. In some embodiments, each honeycomb cell in the structured battery has a diameter of 6.4 mm. FIG. 2 illustrates an example honeycomb layer 200 that can be implemented within a structured battery. As shown, the honeycomb layer 200 includes honeycomb cells, such as honeycomb cells 202, 204, and 206, that are connected to one another to form a planar structure. The shape of the cells of the core is shown along a particular ribbon direction 210.

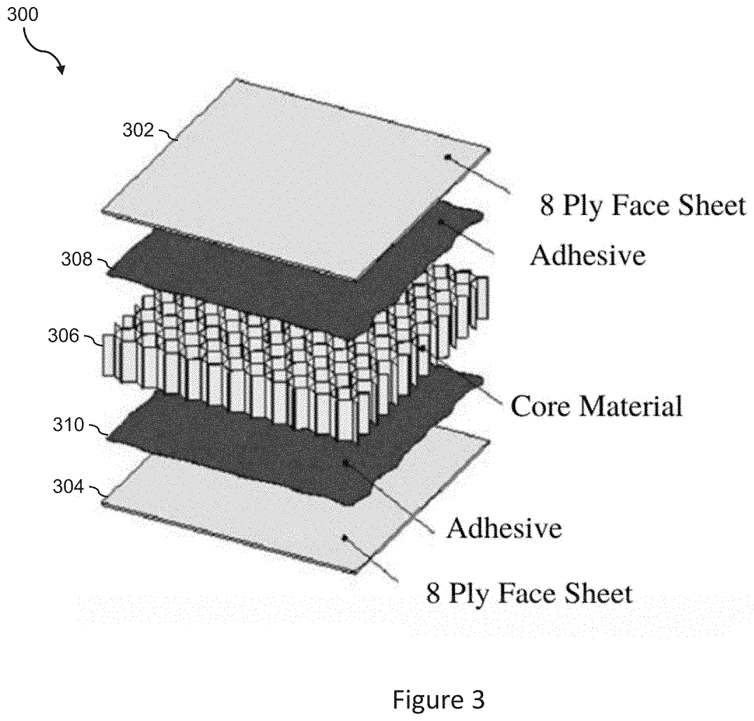

FIG. 3 illustrates another example structured battery 300 that includes a honeycomb layer. As shown in FIG. 3, the structured battery 300 includes two face sheets 302 and 304 and a core 306 that is affixed in between the two face sheets 302 and 304 using an adhesive material 308 and 310. The adhesive material 308 and 310 may be a material that can bond the face sheets and the core together (e.g., a 3M AF-555 adhesive, which is designed for honeycomb bonds).

Each of the face sheets 302 and 304 corresponds to a carbon fiber layer and may include one or more carbon fiber plies. In a non-limited example, each of the face sheets 302 and 304 may include eight carbon fiber plies. The core 306 may include one or more honeycomb layers and one or more layers of graphene battery cells (not shown).

These structured batteries are ideal for applications that require high compressive strength, high bending stiffness, and very low weight such as vehicles. However, one problem with sandwich composites is their susceptibility to low velocity impact damage. Low velocity impacts may result in both external damage, in the form of dents, and internal damage, in the form of core crushing, face sheet delamination's (two adjacent plies (e.g., layers) separating from one another), fiber fractures and matrix cracks. In general, it is assumed that visibly evident damage will be repaired. Barely visible impact damage (BVID) therefore represents a threshold, such that damage of a threshold size or smaller must be considered to exist in flight structure, and structure must therefore be designed to tolerate this level of damage (e.g., within the threshold) without a loss in performance.

In order to design structures appropriately, it is necessary to understand the type and extent of internal damage present at or near the BVID threshold. Such damage assessments are then used as input for structural performance determinations. The particular sandwich composites that were studied are comprised of an aluminum honeycomb core (e.g., a honeycomb layer) and face sheets (e.g., carbon fiber layers) made from multiple plies of unidirectional graphite fibers in an epoxy matrix. The plies in the face sheets have carbon fibers oriented in the 0°, 90°, 45° and (−45)° directions. These plies are relatively stiff in the fiber direction and compliant in the perpendicular direction. Plies of different directions are stacked on top of each other to build face sheets that are quasi-isotropic, i.e., that have the same strength and stiffness in their in-plane directions.

The parameters that can be considered for addressing the damage issue are the core thickness, core density, face sheet stacking sequence (the sequence that the plies in various directions are placed on top of one another), load, and indenter diameter. In this regard, specimens are indented using a quasi-static indentation test. In this test, load is applied monotonically using a fixed diameter indenter until the permanent dent becomes barely visible. This approach has been shown to produce essentially the same type of damage as low-velocity impact, but allows for more consistent and controllable levels of damage to be created. The damage was then evaluated non-destructively via ultrasonics and destructively via cross sectioning and microscopy.

The results obtained by these two methods were then compared and synthesized to obtain an understanding of the internal state of damage as a function of those parameters. It was found that the two parameters that are most important are the face sheet stacking sequence and the core density. In terms of stacking sequence, delamination is most prominent between plies with large differences in their fiber orientations. For adjacent plies with very different fiber directions (i.e., a 90° ply followed by a 0° ply), there is a large mismatch in stiffness and in coefficient of thermal expansion. This causes large shear stresses, which in turn lead to delamination. In addition, stiffer, higher density cores are observed to cause more delamination to occur than lower density, more compliant cores. It is expected that the data and trends collected in this study may be used to provide guidance for choosing structural geometries that optimize weight, cost, and impact resistance for practical structural applications. For example, to construct a carbon fiber layer, multiple plies of carbon fiber composites may be stacked on top of each other. Based on the study, the carbon fiber composites may be stacked on top of each other with a constraint that limits the orientation differential between each pair of adjacent plies to be within a threshold (e.g., 45°, 30°, 60°, etc.).

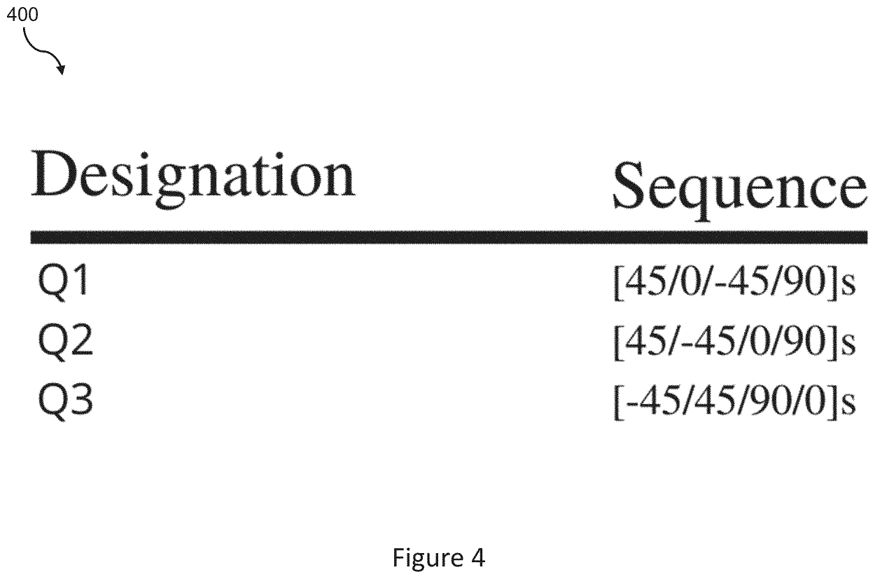

The plies in the face sheet are stacked on top of one another in various orientations with each ply in the 0°, 90°, −45°, or 45° directions. Each face sheet (e.g., each carbon fiber layer) is made from eight plies stacked on top of one another in a particular orientation. FIG. 4 illustrates a table 400 that lists three example face sheet layouts according to some embodiments of the disclosure. The convention is to list the first four plies; the last four are a mirror image of the first four so that the face sheet is symmetric about the mid plane. As shown, an example face sheet may include a first carbon fiber ply that has a 45-degree orientation, followed by a second carbon fiber ply that has a 0-degree orientation, followed by a third carbon fiber ply that has a −45-degree orientation, followed by a fourth carbon fiber ply that has a 90-degree orientation, followed by a fifth carbon fiber ply that has a 90-degree orientation, followed by a sixth carbon fiber ply that has a −45-degree orientation, followed by a seventh carbon fiber ply that has a 0-degree orientation, and followed by an eighth carbon fiber ply that has a 45-degree orientation. Another example face sheet may include a first carbon fiber ply that has a 45-degree orientation, followed by a second carbon fiber ply that has a −45-degree orientation, followed by a third carbon fiber ply that has a 0-degree orientation, followed by a fourth carbon fiber ply that has a 90-degree orientation, followed by a fifth carbon fiber ply that has a 90-degree orientation, followed by a sixth carbon fiber ply that has a 0-degree orientation, followed by a seventh carbon fiber ply that has a −45-degree orientation, and followed by an eighth carbon fiber ply that has a 45-degree orientation. Another example face sheet may include a first carbon fiber ply that has a −45-degree orientation, followed by a second carbon fiber ply that has a 45-degree orientation, followed by a third carbon fiber ply that has a 90-degree orientation, followed by a fourth carbon fiber ply that has a 0-degree orientation, followed by a fifth carbon fiber ply that has a 0-degree orientation, followed by a sixth carbon fiber ply that has a 90-degree orientation, followed by a seventh carbon fiber ply that has a 45-degree orientation, and followed by an eighth carbon fiber ply that has a −45-degree orientation.

This allows the face sheets to be quasi-isotropic. The core is bonded to the face sheets by an adhesive (e.g., a 3M AF-555 adhesive, which is designed for honeycomb bonds).

The structured battery can be used as the body or the encasing of different appliances as illustrated below. These batteries can be used as structural material for:
Electric Vehicles (EVs)
High Consumption Appliances
   Air Conditioning Units
   Refrigerators
   Dishwashers
   Washing Machines
   Dryers
   Microwaves
Semi-Truck Trailers
Recreational Vehicles (RVs)
Semi-Trucks
Vans
Roofing
   Homes
   Industrial Buildings
   Farms
   Offices
   Co-Working Spaces
   Strip Malls
   Schools/Universities
   Medical Facilities
   Retirement Homes
   Mobile Homes

The addition of solar panels on the outer layer of the structure batteries may enable the collection and storage of clean energy for use at a later time. The solar panels may feed directly to the structured battery. This solution effectively turns metal structures into batteries without any additional weight. The more structured batteries used, the more power supplied. This makes the structured battery an excellent choice for large, heavy vehicles. Adding solar ensures continuous charge with little to no loss of power. In the future, this solution could be used to power aircraft due to the battery's incredible energy density and lightweight design.

Using graphene ensures a safe, long-lasting solution. While lithium-ion holds electricity in chemical form, Graphene stores it as an electrical field. This is a lot like static electricity collecting on a balloon. Because graphene does not rely on a chemical reaction, graphene batteries do not degrade like lithium-ion. The battery can last up to sixty years, regardless of the number of charges and discharges. This makes graphene the ideal choice for clean energy storage.

The structured battery is a solid-state battery. Unlike lithium-ion, the structured battery is not prone to overheating, fire, or explosion due to damage.

Graphene

At just one atom thick, graphene can be used to make thin and strong structural component. With a tensile strength of 130 GPa (gigapascals), graphene is around 100 times stronger than steel. graphene is flexible, highly conductive, and impermeable to most gases and liquids.

Residential/Commercial Applications

Graphene provides a safe, reliable option for homeowners and business owners looking to reduce their impact on the environment while ensuring reliable power.

Metal Roofing

Metal roofs have become more popular in recent years. While metal used to be reserved for barns and warehouses, metal roofing has become a popular choice for residential homes and businesses. Metal roofs are more environmentally friendly and last longer than asphalt shingles.

Metal roofs hold up well during extreme weather and include a special protective coating to protect the roof from rust.

When used to replace metal roofs, the structured battery provides safe and reliable power to homes, farms, and office spaces. Unlike metal roofs made from aluminum or copper, the structured battery will not dent if walked on or struck by falling branches or other debris.

The structured battery can be installed like any other metal material. Its strength and durability ensure a long-lasting, safe, and reliable energy storage solution. The structured battery can last up to sixty years and can be charged and discharged multiple times without loss of energy density.

Using structured batteries incorporated with solar panels as roofs of building structure allows for reliable energy storage and consistent power, even in the event of outages or rolling blackouts. This reduces reliance on the grid while reducing energy costs.

Electric Vehicles (EVs)

When used to create electric vehicles (EVs), the structured battery provides a strong surface with exceptional energy density. Unlike lithium-ion batteries, the structured battery does not require additional space and does not add extra weight to the vehicle. The structured battery provides safe, reliable, green energy to the vehicle. The battery will not overheat, catch fire, or explode, even in the event of an accident.

The lightweight and flexible design of the structured battery allows for the use of multiple batteries in the same EV. The material can be used to create the roof, doors, and entire structure of the vehicle. The more batteries used, the longer lasting the power. This makes the structured battery an excellent choice for larger vehicles like semi-trucks, semi-truck trailers, vans, and buses.

Truck Trailers & Small Cargo Vehicles

Currently, diesel fuel is the main fuel used to transport goods across the country. While diesel provides an excellent source of power for semi-trucks and cargo vehicles, it isn't the most environmentally friendly option. Diesel fuel is heavier and oilier than gasoline and diesel engines emit a fair amount of nitrogen compounds and particulate matter into the environment.

Recently, there's been a lot of research into the viability of battery-powered truck trailers and cargo vehicles. While options are starting to appear, driving range and reliability seem to be a major problem. Another issue, lithium-ion batteries take up space, increase vehicle weight, and are prone to fire and explosion. This not only creates a safety hazard for drivers, it could also have a negative impact on a trucking company's reputation. No one wants to learn that the products they've shipped or purchased were damaged in a preventable fire.

Using structured batteries to create the doors, roof, and other structures of the truck trailer or cargo vehicle ensures reliable power with no added weight. Utilizing solar panels installed on the top of the vehicle ensures the battery stays fully charged for long periods of time. The more structured batteries used, the further the vehicle can travel without issue. Unlike other types of batteries, the Structured Battery is not prone to overheating, fire, or explosion even in the event of an accident.

This solution allows the structure of the vehicle itself to generate its own clean, reliable, and safe power.

High Consumption Appliances

The average American home spends more than $2,000 each year on utility bills. This cost is much higher for businesses. U.S. households require energy to power numerous appliances and devices. However, more than half (51%) of a household's energy consumption is used on space heating and air conditioning.

When used to create the structure for high consumption appliances, the Structured Battery reduces energy costs and decreases strain on the grid. The Structured Battery provides safe, green power to major appliances without risk of fire or explosion.

What is claimed is:

1. A structured battery comprising:
a first carbon fiber composite layer;
a second carbon fiber composite layer; and
one or more layers of graphene battery cells disposed between the first and second carbon fiber composite layers.

2. The structured battery of claim 1, further comprising:
one or more honeycomb layers disposed between the one or more layers of graphene battery cells and the first carbon fiber composite layer.

3. The structured battery of claim 2, wherein the one or more honeycomb layers comprise a plurality of honeycomb cells, and wherein each of the plurality of honeycomb cells is made of aluminum.

4. The structured battery of claim 1, further comprising a micro sensor disposed within the one or more layers of graphene battery cells, wherein the micro sensor is configured to detect at least one of a charge level or a temperature associated with the one or more layers of graphene battery cells.

5. The structured battery of claim 4, further comprising a computer processor communicatively coupled to the micro sensor, wherein the computer processor is configured to provide power to a machine based on information detected by the micro sensor.

6. The structured battery of claim 5, wherein the machine comprises an electric vehicle.

7. The structured battery of claim 5, wherein the machine comprises an appliance.

8. The structured battery of claim 1, wherein the first carbon fiber composite layer comprises a plurality of carbon fiber plies, and wherein each pair of adjacent carbon fiber plies has an orientation differential less than a threshold.

9. The structured battery of claim 1, wherein each graphene battery cell in the one or more layers of graphene battery cells comprises:
a positive current collector attached to a graphene anode;
a negative current collector attached to a graphene cathode; and
a separator that separates the graphene anode and the graphene cathode.

10. A method of manufacturing a structured battery, comprising:
generating a first carbon fiber layer and a second carbon fiber layer;
generating one or more layers of graphene battery cells; and
disposing the one or more layers of graphene battery cells between the first carbon fiber layer and the second carbon fiber layer.

11. The method of claim 10, further comprising:
generating a honeycomb layer; and
disposing the honeycomb layer between the first carbon fiber layer and the one or more layers of graphene battery cells.

12. The method of claim 11, wherein the honeycomb layer comprises a plurality of honeycomb cells.

13. The method of claim 12, wherein the plurality of honeycomb cells is made with a material having a heat conductivity metric above a threshold.

14. The method of claim 10, further comprising connecting a negative electrode and a positive electrode to the one or more layers of graphene battery cells.

15. The method of claim 10, wherein the generating the first carbon fiber layer comprises:
generating a plurality of carbon fiber plies; and
stacking a first carbon fiber ply from the plurality of carbon fiber plies on top of a second carbon fiber ply from the plurality of carbon fiber plies.

16. The method of claim 15, wherein the stacking the first carbon fiber ply on top of the second carbon fiber ply comprises:
orienting the first carbon fiber ply in a first orientation with respect to a second orientation of the second carbon fiber ply such that a differential between the first orientation and the second orientation is larger than zero and smaller than a threshold.

17. The method of claim 10, further comprising:
disposing a micro sensor on the one or more layers of graphene battery cells, wherein the micro sensor is configured to detect at least one of a charge level or a temperature of the one or more layers of graphene battery cells; and
connecting the micro sensor to a computer processor.

18. The method of claim 17, wherein the computer processor is configured to provide power to a machine based on information detected by the micro sensor.

19. The method of claim 18, further comprising connecting the structured battery to a solar panel.

20. A vehicle comprising the structured battery of claim 1, wherein the structured battery is integrally formed into at least one of a hood, a roof, or a trunk of the vehicle.
